(19) United States
(12) Patent Application Publication
(10) Pub. No.: US 2009/0207041 A1
(43) Pub. Date: Aug. 20, 2009

(54) DOWNHOLE MEASUREMENT WHILE DRILLING SYSTEM AND METHOD

(75) Inventors: Ralf Zaeper, Hannover (DE); Michael W. King, Houston, TX (US)

Correspondence Address: CANTOR COLBURN, LLP, 20 Church Street, 22nd Floor, Hartford, CT, 06103, US

(73) Assignee: Baker Hughes Incorporated, Houston, TX (US)

(21) Appl. No.: 12/388,995

(22) Filed: Feb. 19, 2009

Related U.S. Application Data
(60) Provisional application No. 61/029,676, filed on Feb. 19, 2008.

(51) Int. Cl. G01V 3/00

(52) U.S. Cl. 340/855.3; 340/856.3

(57) ABSTRACT

A method of measuring while drilling includes positioning at least one sensor downhole; and transmitting sensed data while drilling from the at least one sensor to surface without storing the sensed data downhole and system.

### CROSS REFERENCE TO RELATED APPLICATIONS

This application claims priority to U.S. Provisional Application No. 61/029,676 filed on Feb. 19, 2008, the entire contents of which are incorporated herein by reference.

### BACKGROUND OF THE INVENTION

The hydrocarbon recovery industry is always in search of ways to increase efficiency of extracting hydrocarbons. Improving an understanding of the downhole conditions encountered while drilling is beneficial in this endeavor. As such, operators are employing more electronics with increasing complexity toward this objective. Unfortunately, as the quantity and complexity of electronics deployed downhole increases, so does the number of potential failure modes and instances of failures. Systems, therefore, that allow fewer, less complex and more durable electronics to be employed downhole while maintaining the improved understanding of the downhole conditions as noted above are desirable in the art.

### BRIEF DESCRIPTION OF THE INVENTION

A method of measuring while drilling includes positioning at least one sensor downhole; and transmitting sensed data while drilling from the at least one sensor to surface without processing the sensed data downhole.

A downhole measurement while drilling system includes at least one sensor-sub at a drillstring locatable downhole during a wellbore operation, the sensor-sub having at least one sensor; and a communication medium at the drillstring configured to transmit sensed data between the at least one sensor-sub and a surface processor, the downhole measurement while drilling system being without downhole processing of at least 40 percent of the sensed data.

### BRIEF DESCRIPTION OF THE DRAWINGS

The following descriptions should not be considered limiting in any way. With reference to the accompanying drawings, like elements are numbered alike:

FIG. 1 depicts a schematical view of a downhole measurement while drilling system disclosed herein.

FIG. 2 is an enlarged view of the sensor-sub portion of the system illustrated in FIG. 1.

### DETAILED DESCRIPTION OF THE INVENTION

A detailed description of one or more embodiments of the disclosed apparatus and method are presented herein by way of exemplification and not limitation with reference to the Figures.

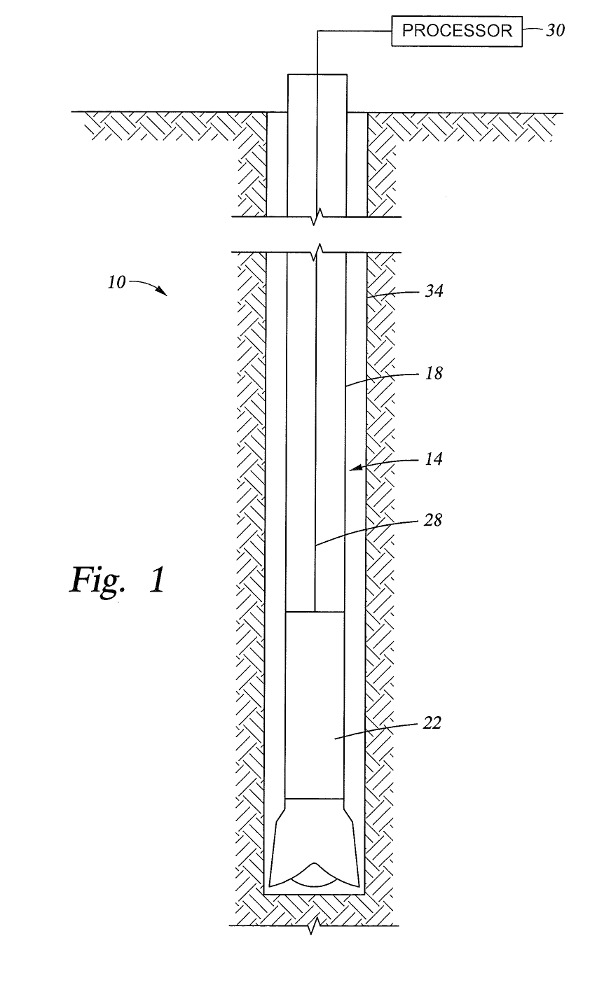

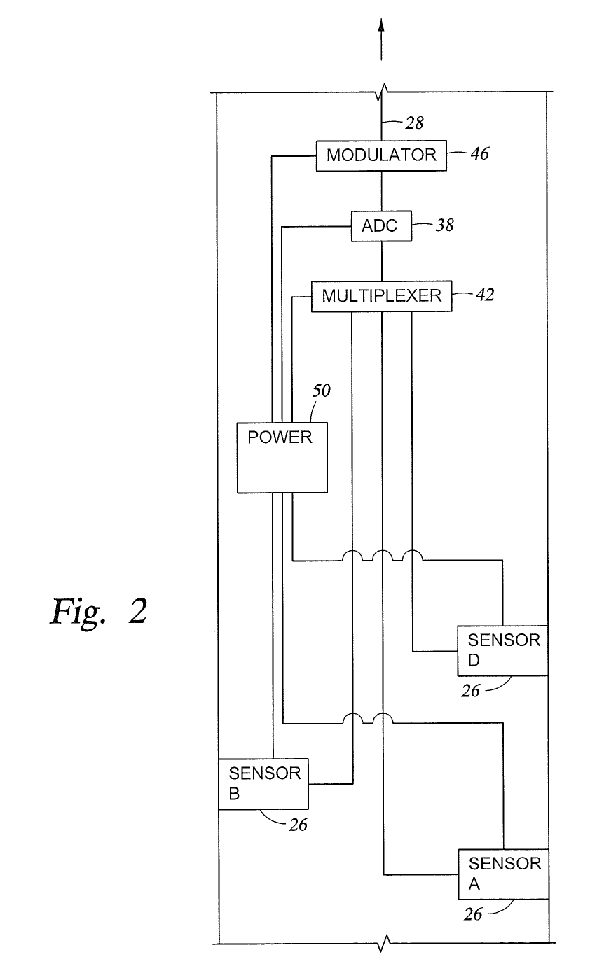

Referring to FIG. 1 and FIG. 2, an embodiment of the downhole measurement while drilling system 10 disclosed herein is illustrated. The measurement while drilling system 10 includes, a drillstring 14 having a high speed communication channel 18 and at least one sensor-sub 22, with each sensor-sub 22 having at least one sensor 26, and a processor 30 at surface (or other remote location) that is communicatively coupled with the at least one sensor-sub 22 and the at least one sensor 26 via a communication medium 28 in the drill string 18. The sensor-sub 22 is positionable downhole within a wellbore 34 during well operations, such as drilling, for example. The system 10 communicates, in one embodiment at least about 40 percent of sensed data from at least one sensor to the processor 30 via the high speed channel 18 without being processed downhole. In another embodiment, the communicated unprocessed data is about 50 percent of the sensed data from the at least one sensor and in yet another embodiment 100 percent of the sensed data is communicated uphole unprocessed. It should be understood that the term “sensed data” as used herein means data acquired from the sensor(s) 26. As such, data that has been digitized, or compressed, for example, is still considered sensed data as long as it originated from the sensor(s) 26.

The at least one sensor 26 may be any of the following; a pressure sensor, a strain sensor, an acceleration sensor, a temperature sensor, an acoustic sensor, a gravitational field sensor, a gyroscope, a resistivity sensor, a weight sensor, a torque sensor, a bending-moment sensor, a vibration sensor, a rotation sensor, a rate of penetration sensor, a magnetic field sensor, NMR, geophone, hydrophone, formation sampling, a caliper, an electrode, a gamma ray detector, a density sensor, a neutron sensor, a dipmeter, an imaging sensor, and other sensors useful in well logging and well drilling. The sensor(s) 26 may output an analog signal, a digital signal or both an analog signal and a digital signal.

Each of the at least one sensor-sub 22, in addition to having at least one sensor 26 may also include, one or more analog-to-digital converter (ADC) 38, one or more multiplexers 42, one or more modulators 46 and one or more power supplies 50. The one or more power supplies 50 can be configured to supply power to each of, the sensor(s) 26, ADC(s) 38, multiplexer(s) 42 and modulator(s) 46. Some embodiments of the invention, however, may not employ a separate power supply 50 as power may be supplied from surface via the communication medium 28 in the pipe 18, for example.

The ADC(s) 38, if employed, can convert analog signals from the one or more sensors 26 (for analog sensors) attached thereto to digital signals prior to transmission to surface over the communication medium 28. Transmitting (modulated) digital signals may be preferred over transmitting analog signals for reasons commonly known such as, error avoidance, error correction, efficient use of available bandwidth and low power requirements, for example.

The multiplexer(s) 42, if employed, can permit multiple signals, either analog or digital, to be transmitted over the single communication medium 28. The multiplexer(s) 42 also permits the use of a plurality of the sensors 26 while using a single or reduced number of ADCs 38, thereby saving the costs and complexity associated with multiple, parallel operating ADCs 38. Additionally, the multiplexer(s) 42 can reduce the number and complexity of circuit components employed downhole, thereby reducing system failures that may have occurred had the number and complexity of components not been reduced.

The modulator(s) 46, if employed, can modulate the signal, whether it is analog or digital, to optimize transmission over the communication medium 28 available. The modulator(s) 46 can modulate the signals with a modulating scheme, such as phase-shift keying (PSK), frequency-shift keying (FSK) and amplitude-shift keying (ASK), for example. A signal from one of the sensor(s) 26 may form a base-band signal for the modulation. The processor 30 at surface can distinguish data from each of the sensor(s) 26 by channel of transmission, timing sequence, transmission pattern or any other recognition scheme employed by the system 10. The modulator(s) 46, multiplexer(s) 42 and ADC(s) 38 can be used separately or together to transmit large amounts of data from the sensors 26 to the processor 30 at the surface via the communication medium 28, of the drill pipe 18. The ability to transmit large amounts of data to surface allows the sensor-sub(s) 22 to be less complex, have fewer parts, have fewer potential failure modes and be more robust in the downhole environment within which the sensor-sub(s) 22 is required to function. In fact, the system disclosed herein has no downhole storage for sensed data produced by the sensor(s) 26.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A method of measuring while drilling, comprising:
positioning at least one sensor downhole; and
transmitting at least about 40 percent of sensed data while drilling from the at least one sensor to surface without processing the sensed data downhole.

2. The method of measuring while drilling of claim 1, further comprising communicatively coupling the at least one sensor to surface via wired pipe.

3. The method of measuring while drilling of claim 1, further comprising digitally modulating the sensed data with one of phase-shift keying (PSK), frequency-shift keying (FSK) and amplitude-shift keying (ASK).

4. The method of measuring while drilling of claim 1, further comprising digitizing the sensed data.

5. The method of measuring while drilling of claim 1, further comprising multiplexing a plurality of signals from the sensor(s) to a single analog-to-digital converter.

6. The method of measuring while drilling of claim 1, further comprising multiplexing a plurality of signals from the sensor(s) to a single communication medium.

7. A downhole measurement while drilling system comprising:
at least one sensor-sub at a drillstring locatable downhole during a wellbore operation, the sensor-sub having at least one sensor; and
a communication medium at the drillstring configured to transmit sensed data between the at least one sensor-sub and a surface processor, the downhole measurement while drilling system being without downhole processing of at least 40 percent of the sensed data.

8. The downhole measurement while drilling system of claim 7, further comprising at least one multiplexer in operable communication with the at least one sensor.

9. The downhole measurement while drilling system of claim 7, further comprising at least one analog-to-digital converter in operable communication with the at least one sensor.

10. The downhole measurement while drilling system of claim 7, further comprising at least one modulator in operable communication with the at least one sensor.

11. The downhole measurement while drilling system of claim 7, further comprising at least one power supply in operable communication with the at least one sensor.

12. The downhole measurement while drilling system of claim 7 wherein the sensed data communicated is at least 50 percent unprocessed.

13. The downhole measurement while drilling system of claim 7 wherein the sensed data communicated is at least 100 percent unprocessed.

14. The downhole measurement while drilling system of claim 7 wherein the at least one sensor is a drilling dynamics sensor.

15. The downhole measurement while drilling system of claim 14 wherein the drilling dynamics sensor is selected from the group consisting of an acceleration sensor, a strain sensor, a gyroscope, a gravitational field sensor, a temperature sensor, a weight sensor, a torque sensor, a bending-moment sensor, a vibration sensor, a rotation sensor, a rate of penetration sensor, and a magnetic field sensor.

16. The downhole measurement while drilling system of claim 7 wherein the at least one sensor is a formation evaluation sensor.

17. The downhole measurement while drilling system of claim 16 wherein the formation evaluation sensor is selected from the group consisting of a pressure sensor, a temperature sensor, an acoustic sensor, a gravitational field sensor, a resistivity sensor, a rate of penetration sensor, a magnetic field sensor, an electrode, a gamma ray detector, a density sensor, a neutron sensor, an imaging sensor, NMR, geophone, hydrophone, a formation sampling, and a dipmeter.

18. A method of measuring while drilling, comprising:
positioning at least one sensor downhole; and
transmitting sensed data while drilling from the at least one sensor to surface without processing the sensed data downhole.
